(19) United States
(12) Patent Application Publication
(10) Pub. No.: US 2008/0299827 A1
(43) Pub. Date: Dec. 4, 2008

(54) Electrical connector with metal shell having convex hull extending from the surface of the front portion thereof

(75) Inventor: Ssu-Min Lung, Tu-cheng (TW)

Correspondence Address: WEI TE CHUNG;FOXCONN INTERNATIONAL, INC., 1650 MEMOREX DRIVE, SANTA CLARA, CA, 95050, US

(73) Assignee: HON HAI PRECISION IND. CO., LTD.

(21) Appl. No.: 12/069,891

(22) Filed: Feb. 12, 2008

(30) Foreign Application Priority Data
Feb. 12, 2007 (TW) 96202652

(51) Int. Cl. H01R 13/648

(52) U.S. Cl. 439/607

(57) ABSTRACT

An electrical connector comprising an insulative housing having a base potion and a tongue portion extending therefrom; a plurality of contacts arranged in the insulating housing; and a metal shell receiving the insulative housing therein, comprising a main shell and a sub shell attached to the main shell; the main shell having a front shroud portion surrounding the tongue portion of the insulative housing, wherein at least one embossed portion extending from the front shroud portion, and a rear portion supporting the base portion; the sub shell attached to the rear portion of the main shell and having a curve portion abutting against the front end of the front shroud portion to enclose the base portion of the insulative housing.

### BACKGROUND OF THE INVENTION

1. Field of the Invention

The present invention generally relates to an electrical connector, and more particularly relates to an electrical connector with a metal shell having at least one embossed portion extending from the front shroud portion thereof.

2. Description of Related Arts

Electrical connection between a system and peripherals is established through a receptacle connector and a plug connector. Generally, the receptacle with recessed space is installed in the system and the plug with protruding front mating portion is extended from a peripheral, such as a cable end.

Chinese Patent CN No. 2886835 Y discloses an electrical connector, i.e. a plug connector. The plug connector typically comprises a separable metal shell, an insulative housing and a plurality of contacts. When the plug connector is connected with the receptacle, the retention force for securing the plug within the receptacle is ensured by the normal force between contacts of receptacle connector and contacts of plug connector. The receptacle and plug connector assembly are often jerked out by accidental force if the retention force is not robust enough.

Hence, an improved electrical connector is required to overcome the aforesaid disadvantages of the prior art.

### SUMMARY OF THE INVENTION

It is an object of the present invention to provide an electrical connector with a metal shell, which can supply enough retention force.

In order to achieve the above-mentioned object, an electrical connector includes an insulative housing, a separable metal shell and a plurality of contacts disposed in the insulative housing. The insulative housing includes a base portion and a tongue portion extending therefrom. The separable metal shell includes a main shell and a sub shell attach to the main shell, the main shell having a front shroud portion surrounding the tongue portion of the insulative housing, wherein at least one embossed portion extending from the front shroud portion, and a rear portion supporting the base portion; the sub shell attached to the rear portion of the main shell and having a curve portion abutting against the front end of the front shroud portion to enclose the base portion of the insulative housing.

Other objects, advantages and novel features of the invention will become more apparent from the following detailed description of the present embodiment when taken in conjunction with the accompanying drawings.

### BRIEF DESCRIPTION OF THE DRAWING

FIG. 1 is a perspective view of an electrical connector in accordance with the present invention;

FIG. 2 is an exploded view of the electrical connector shown in FIG. 1;

FIG. 3 is a perspective view of the electrical connector in FIG. 1 from another direction, the sub shell is hidden; and

FIG. 4 is an exploded view of the electrical connector showing when the sub shell is covering the assembled main shell;

### DETAILED DESCRIPTION OF THE PREFERRED EMBODIMENT

Reference will now be made to the drawing figures to describe the present invention in detail.

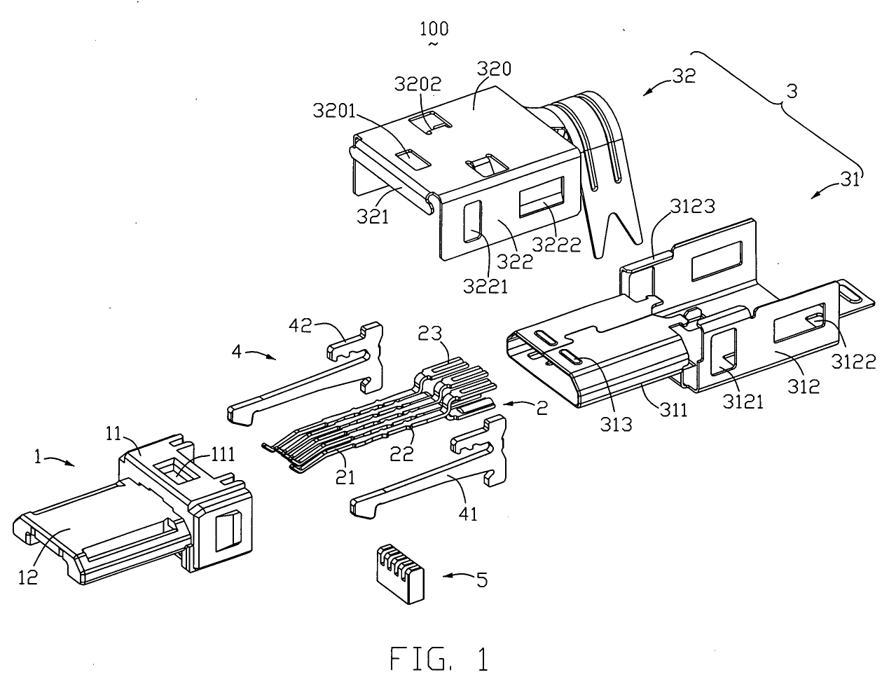

As shown in FIG. 1, an electrical connector 100 in accordance with the present invention typically comprises a separable metal shell 3, an insulative housing 1 and a plurality of contacts 2. A pair of locking pieces 4 and a block 5 are further received in the insulative housing 1.

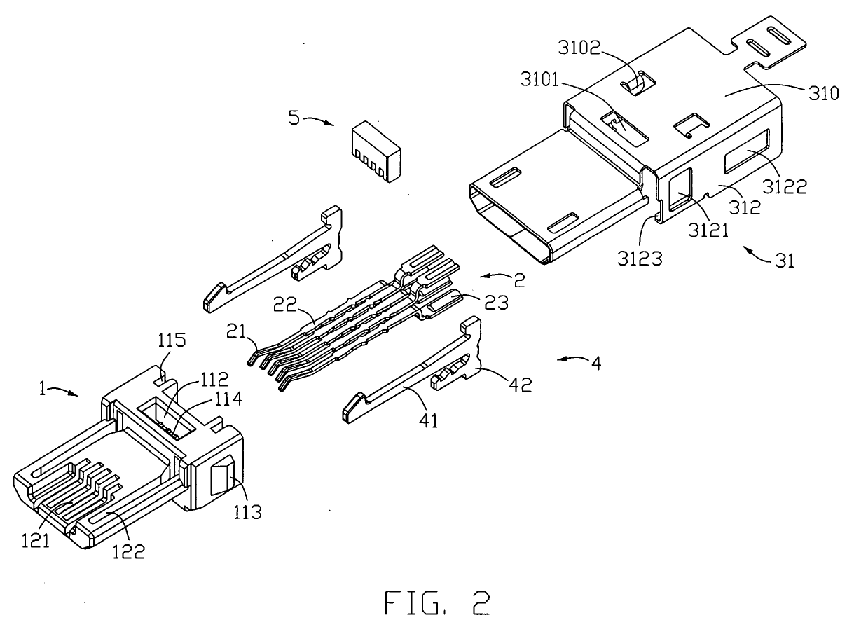

Referring to FIG. 1 and FIG. 2, the insulative housing 1 includes a base portion 11 and a tongue portion 12 extending therefrom. The base portion 11 defines a first cave 111 in the top surface and a second cave 112 in the bottom surface. A pair of projections 113 extends from the both sides of the base portion 11. There is a plurality of first recesses 114 running through the base portion 11 in the longitudinal direction. A pair of first slots 115 run through the base portion 11 near the first recesses 114. Relating to the first recesses 114 and the first slots 115, there are second recesses 121 and second slots 122 located at the tongue portion 12. The first and second recesses 114,121 receive the contacts 2 in themselves, and the first and second 115,122 receive the locking pieces 4 in themselves.

Referring to FIG. 1 and FIG. 2, the contacts 2 have a touching portion 21, a connecting portion 22 neighbor on the touching portion 21, and a welding portion 23 closely vicinity to the connecting portion 22. The touching portion 21 is connected with the mating connector (not shown), however the welding portion 23 is connected with a cable (not shown) or others.

Referring to FIG. 1 to FIG. 3, the metal shell 3 receiving the insulative housing 1 therein, comprising a main shell 31 and a sub shell 32 attach to the main shell 31; the main shell 31 has a front shroud portion 311 surrounding the tongue portion 12 of the insulative housing 1, defines a pair of opposite walls namely first sidewalls 312, at least one embossed portion 313 extending from the surface of the front shroud portion 311, includes a pair of first and second openings 3121, 3122 in the first sidewalls 312 and a pair of fins 3123 extending from the first sidewalls 312, and further defines a bottom wall 310 on which a first hole 3101 and a pair of bottom curve arms 3102 mounted connecting the first sidewalls together;

The sub shell 32 has a curve portion 321 abutting against the front end of the base portion 11, defines a pair of opposite walls namely second sidewalls 322 corresponding to the first sidewalls 312, includes a pair of lugs 3222 and a pair of third openings 3221 respectively corresponding to the second and first openings, and further defines a top wall 320 on which a second hole 3201 and a pair of top curve arms 3202 mounted connecting the second sidewalls 322 together.

Referring to FIG. 1 and FIG. 2, the locking pieces 4 comprise locking portion 41 and holding portion 42, when assembling, the holding portion 42 and the locking portion 41 are respectively received in the first and second slots 115,122 of the insulative housing 1.

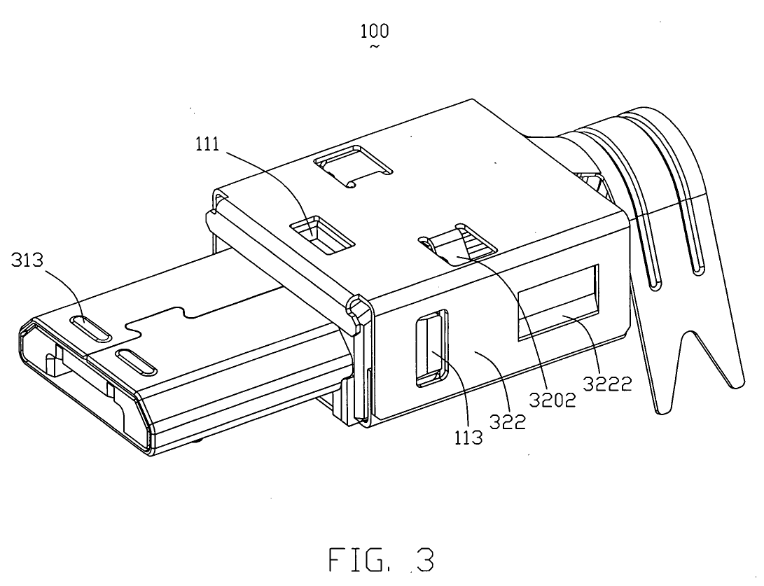

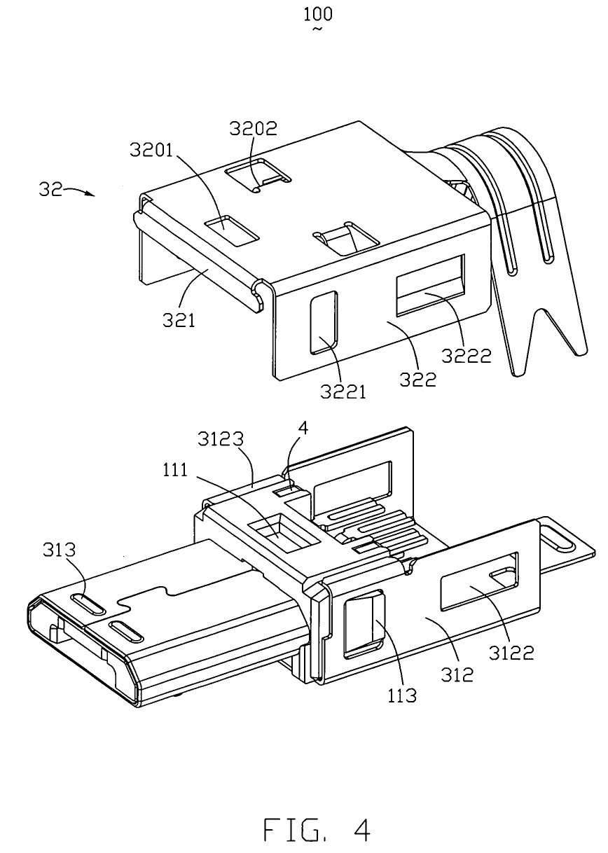

Referring to FIG. 4, insert the contacts 2 and the locking pieces 4 into the insulative housing 1 from the rear end, the contacts 2 are received into the first and second recesses 114,121, wherever the locking pieces 4 are received into the first and second slots 115,122. The main shell 31 contains the insulative housing 1 therein, putting the block 5 in the first cave 111 of the insulative housing 1. Cover the sub shell 32 over the main shell 31 in quick succession. The electrical connector 100 is assembly shown as FIG. 3.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An electrical connector comprising:
an insulative housing having a base potion and a tongue portion extending therefrom;
a plurality of contacts arranged in the insulating housing; and
a metal shell receiving the insulative housing therein, comprising a main shell and a sub shell attached to the main shell; the main shell having a front shroud portion surrounding the tongue portion of the insulative housing, wherein at least one embossed portion extending from the front shroud portion, and a rear portion supporting the base portion; the sub shell attached to the rear portion of the main shell and having a curve portion abutting against the front end of the front shroud portion to enclose the base portion of the insulative housing.

2. The electrical connector as described in claim 1, wherein the insulative housing having a pair of projections extending from both sides of the base portion, a pair of first and second sidewalls formed on the metal shell defining a pair of first and second openings respectively corresponding to the projections.

3. The electrical connector as described in claim 2, further comprising a pair of locking pieces received in the insulative housing to secure engagement with a mating connector.

4. The electrical connector as described in claim 3, wherein the main and sub shell having bottom curve arms and top curve arms abutting against the rear end of the locking pieces.

5. The electrical connector as described in claim 1, wherein further comprising a block touching the contacts received in the insulative housing.

6. A metal shell made of a piece of metal sheet and receiving the insulative housing therein, comprising:
a main shell and a sub shell attached to the main shell;
the main shell having a front shroud portion surrounding the tongue portion of the insulative housing, wherein at least one embossed portion extending from the front shroud portion, and a rear portion supporting the base portion, further the rear portion having a pair first sidewalls that define a pair of first and second openings and a pair of fins extending therefrom, including a bottom wall on which a first hole and a pair of bottom curve arms are mounted connecting the first sidewalls together;
the sub shell attached to the rear portion of the main shell having a curve portion abutting against the front end of the front shroud portion to enclose the base portion of the insulative housing, further defining a pair of second sidewalls that defines a pair of third openings and lugs respectively corresponding to the first and second openings, including a top wall on which a second hole and a pair of top curve arms mounted connecting the second sidewalls together.

7. An electrical connector comprising:
a unitary insulative housing including a base with a mating tongue extending forwardly from a middle portion of a front face of the base, a retention gap defined in a front portion of the base and forwardly communicating with an exterior adjacent to said mating tongue;
a unitary main shell having a rear section partially enclosing the base, a front section extending, via a neck section, from the rear section in a form of shroud essentially fully surrounding the mating tongue, and a retaining lancing device horizontally extending rearward from a rear edge of the front section and into the retention gap for retaining the main shell to the housing; and
a unitary secondary shell assembled to the main shell and cooperating with said man shell to fully enclosing the base.

8. The electrical connector as claimed in claim 7, wherein the secondary shell further includes an abutment portion abutting against said front face of the base and adjacent to said retaining lancing device.

9. The electrical connector as claimed in claim 8, wherein said abutment portion of the secondary shell and said neck section of the main shell are respectively located by two sides of the front section of the main shell.
